(19) United States
(12) Patent Application Publication
(10) Pub. No.: US 2018/0353942 A1
(43) Pub. Date: Dec. 13, 2018

(54) NANO-ENGINEERED CATALYSTS FOR DRY REFORMING OF METHANE

(71) Applicants: Xinhua LIANG, Rolla, MO (US); Zeyu SHANG, Rolla, MO (US); Shiguang LI, Mount Prospect, IL (US)

(72) Inventors: Xinhua LIANG, Rolla, MO (US); Zeyu SHANG, Rolla, MO (US); Shiguang LI, Mount Prospect, IL (US)

(73) Assignees: GAS TECHNOLOGY INSTITUTE, DES PLAINES, IL (US); THE CURATORS OF THE UNIVERSITY OF MISSOURI, COLUMBIA, MO (US)

(21) Appl. No.: 16/007,395

(22) Filed: Jun. 13, 2018

Related U.S. Application Data
(60) Provisional application No. 62/518,904, filed on Jun. 13, 2017.

(51) Int. Cl. B01J 23/89; B01J 23/755; B01J 23/83; B01J 23/78; B01J 21/04; B01J 35/00; B01J 35/06; C01B 3/40

(52) U.S. Cl. CPC B01J 23/892; B01J 23/755; B01J 23/83; B01J 23/78; B01J 21/04; B01J 35/0013; C01B 2203/1241; B01J 35/06; C01B 3/40; C01B 2203/0238; C01B 2203/1058; C01B 2203/1082; B01J 35/0006

(57) ABSTRACT

Catalysts and processing useful in the dry reforming of methane (DRM) are provided. Catalyst are composed of nickel (Ni) nanoparticles supported on a hollow fiber substrate, such as an α-Al₂O₃ hollow fiber. The nickel (Ni) nanoparticles can be deposited onto the hollow fiber substrate support by atomic layer deposition. If desired, one or more layers of an overcoat of a promoter can be applied to increase catalyst performance such as in the reforming of methane.

### CROSS REFERENCE TO RELATED APPLICATION

This application claims the benefit of U.S. Provisional Patent Application, Ser. No. 62/518,904, filed on 13 Jun. 2017. The co-pending Provisional Application is hereby incorporated by reference herein in its entirety and is made a part hereof, including but not limited to those portions which specifically appear hereinafter.

### BACKGROUND OF THE INVENTION

### Field of the Invention

This invention relates generally to the methane reforming and, more particularly, to catalysts and processing useful in the dry reforming of methane (DRM).

### Description of Related Art

Syngas or synthesis gas is a mixture of primarily hydrogen and carbon monoxide commonly used as a feedstock in Fischer-Tropsch synthesis. Syngas is a primary building block used to create many products and chemicals currently generated by the petrochemical industry. In 2014, the global syngas production was 116,600 Mth, which translates to 11.6 trillion cubic feet (or 3.3×10¹¹ m³). Syngas has maintained market price stability of $0.10-$0.11/m³. This translate to a value of the market in the range of μ$33-36 billion. The market is estimated to reach 213,100 MWth (6.0×10¹¹ m³) by 2020, at a compound annual growth rate (CAGR) of 9.5% or even higher between 2015 and 2020. The projected syngas market for 2025 is shown in FIG. 1 and with the U.S. occupying 28.7% of the global market.

As shown in Table 1, the H₂/CO ratios for the common state-of-the-art syngas production technologies of methane steam reforming reaction, partial oxidation of biomass, and underground coal gasification, are >3, 1.0, and 2, respectively.

Currently, the methane steam reforming reaction (CH₄+H₂O [symbol] CO+3H₂) is the most conventional method of producing syngas with partial oxidation of biomass as an alternative method for producing syngas. The H₂/CO ratio for typical biomass-derived syngas is about 1.0, with many side products being produced, such as tar, ammonia, and sulfur compounds. While the gaseous products can be used to produce liquid fuels and chemicals, tar is produced as a side product. Such tar is or can be difficult to remove and is also or may be to the catalyst and processing units.

Syngas can also be produced from coal. Underground coal gasification is a promising technology for reducing the cost of producing syngas from coal. In underground coal gasification, a gas mixture (containing H₂, CO, CO₂, CH₄, and possibly small quantities of various contaminants including SOx, NOx and H₂S, for example) is produced and extracted through wells drilled into an unmined coal seam. Injection wells are used to supply oxidants (e.g., air or oxygen) and steam to ignite and fuel underground combustion, which is conducted at temperatures from 700 to 900° C.

Among the common state-of-the-art syngas production technologies, methane steam reforming is the most mature technology for large scale syngas production. Methane steam reforming is typically carried out in a packed bed reactor at high pressure (i.e., 2.0-2.6 MPa). The H₂/CO ratio is greater than 3 due to the water-gas shift reaction (H₂O+CO [symbol] CO₂+H₂), making it more valuable to produce high-purity Hz or low-carbon-content chemicals such as methanol.

Current methane dry reforming technologies for producing syngas commonly employ packed bed reactors, where metal catalysts (e.g., Rh, Pt, Ir, Pd, Ru, and Ni) are utilized to catalyze the reaction. Among these metal catalysts, noble metal catalysts have shown better resistance to coking, as compared to Ni catalysts. However, due to the limited availability and high cost of noble metals, there is a need and a demand for the development of a suitable non-noble metal catalyst for use in methane dry reforming.

### SUMMARY OF THE INVENTION

One aspect of the current development relates to a new nickel (Ni) nanoparticle catalyst, supported on a hollow fiber substrate, such as an α-Al₂O₃ hollow fiber substrate support. In one embodiment, extremely small Ni nanoparticles were successfully deposited on hollow fibers to form desired catalyst material. In one embodiment, a new nickel (Ni) nanoparticle catalyst, supported on a hollow fiber substrate, is synthesized by atomic layer deposition (ALD).

In another aspect of the current development, such a catalyst can desirably be employed to catalyze DRM reaction. In one embodiment, such a catalyzed DRM reaction produced or showed a methane reforming rate of 2040 Lh⁻¹ gNi⁻¹ at 800° C.

In another aspect of the current development, a method for producing a catalyst for dry reforming methane is provided. In one embodiment, such a method involves depositing nickel (Ni) nanoparticles onto a hollow fiber substrate support, such as of α-Al₂O₃, by atomic layer deposition. If desired, one or more layers of a promoter coating, such as of Al₂O₃, can be applied over the nickel (Ni) nanoparticles on the hollow fiber substrate support, such as by atomic layer deposition.

As used herein, references to “Ni nanoparticles” are in accordance with one preferred embodiment to be understood to encompass nanoparticles of nickel including nanoparticles of only nickel as well as nanoparticles of nickel-containing combinations such as nickel containing bimetallic nanoparticles such as Ni+Co bimetallic nanoparticles and/or Ni+Pt bimetallic nanoparticles, for example. In accordance with one preferred embodiment, Ni nanoparticles used in the practice of the invention are desirably composed of nanoparticles of neat nickel, e.g., only nickel.

### BRIEF DESCRIPTION OF SEVERAL VIEWS OF THE DRAWINGS

Objects and features of this invention will be better understood from the following description taken in conjunction with the drawings, wherein:

FIG. 1 is a chart showing a projected global syngas market for 2025.

FIG. 2a is a TEM image showing 2-3 nm ALD deposited Ni nanoparticles on 20-30 nm silica particles.

FIG. 2b is a TEM image showing 3-4 nm ALD-deposited Ni nanoparticles on 50-100 nm γ-alumina particles.

FIG. 2c is a TEM image showing Ni nanoparticles deposited on nonporous α-alumina nanoparticles by ALD.

FIG. 3 is a TEM image showing Ni nanoparticles synthesized by a conventional liquid phase method.

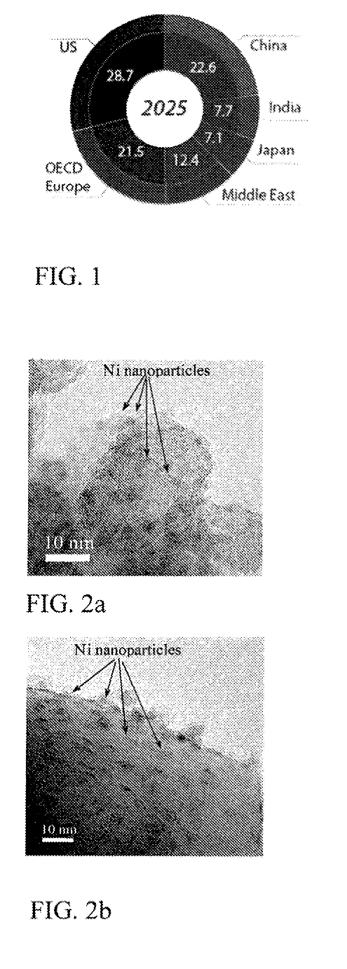

### DETAILED DESCRIPTION

As identified above, in accordance with one aspect of the subject development, a new nickel (Ni) nanoparticle catalyst, supported on a hollow fiber substrate is provided.

Though γ-Al₂O₃ has been widely used as support for Ni-based catalysts, it is not suitable for the industrial DRM process due to phase transformation when the temperature is higher than 770° C., which also accompanies with a decrease in surface area. Among different phases of Al₂O₃, α-Al₂O₃ is the most stable phase. The better thermal and mechanical stability of α-Al₂O₃, as compared to other phases of Al₂O₃, makes it more suitable for industrial application and α-Al₂O₃ has been employed to prepare industrial packed bed catalyst support.

In one embodiment, such a catalyst material in accordance with the subject development can desirably be synthesized by atomic layer deposition (ALD). For example, in the ALD process, a NiAl₂O₄ spinel is formed when Ni nanoparticles are deposited on alpha-alumina substrates, such as can act to inhibit sintering of the Ni nanoparticles.

A coat or coatings of one or more promoters, such as of Al₂O₃, CeO₂, CaO and La₂O₃, for example, can be employed such as to increase catalyst performance such as by further improving the interaction between the Ni nanoparticles and the hollow fiber substrate supports. In one embodiment, such a promoter coating produced or synthesized by atomic layer deposition (ALD) is desirably employed. In one particular embodiment, Al₂O₃ ALD films, can be employed to further improve the interaction between the Ni nanoparticles and the hollow fiber support. Different cycles (e.g., 2, 5, and 10) of promoter, e.g., Al₂O₃ ALD, films have been applied on the hollow fiber supported Ni catalysts. For example, both catalyst activity and stability were improved with the deposition of the Al₂O₃ ALD overcoat films. Among the ALD coated catalysts, the catalysts with 5 cycles of Al₂O₃ ALD exhibited the best performance, e.g., catalyst activity and stability, in the reforming of methane. Those skilled in the art and guided by the teachings herein provided will understand and appreciate that the broader practice of the invention is not necessarily limited by the method or technique by which the metal oxide promoter, if present, is prepared as, for example, the metal oxide promoters can be prepared by alternative methods such as liquid phase impregnation, for example.

Table 1, below, identifies H₂/CO ratios for the common state-of-the-art syngas production technologies of methane steam reforming reaction, partial oxidation of biomass, and underground coal gasification, as well as for dry reforming of methane in accordance with the invention.

TABLE 1
H₂/CO ratios of syngas production technologies.

| Technology | H₂/CO ratio |
|---|---|
| Methane steam reforming | >3 |
| Partial oxidation of biomass | 1.0 |
| Underground coal gasification | 2 |
| Dry reforming of methane (this invention) | 0.70-0.95 |

In contrast with the H₂/CO ratios for the common state-of-the-art syngas production technologies of methane steam reforming reaction, partial oxidation of biomass, and underground coal gasification, of >3, 1.0, and 2, respectively, the projected H₂/CO ratio of dry reforming using the invention technology is 0.70-0.95, which H₂/CO ratio is more favorable for C₅₊ hydrocarbon production.

It is envisioned that, at full scale, the subject technology can utilize CO₂ captured from a coal-fired power plant (550 MWe), at approximately 11,000 tons of CO₂/day, which can produce 790 million standard cubic feet of syngas/day using the dry reforming technology. Please note that this is simply estimated by the chemical reaction equation (CO₂+CH₄→2H₂+2CO). The global syngas market is estimated to reach 6.0×10¹¹ m³ by 2020. If this amount of syngas is produced by the subject technology, approximately 3.0×10⁸ ton CO₂ will be consumed per year. This is the equivalent to the total CO₂ emission from 420 coal-fired power plants (each with 550 MWe (net) capacity). Moreover, technologies for syngas conversion to valuable fuels and chemicals, such as transportation fuels, are currently being developed. Thus, if the economics of syngas conversion processes improve, the market for syngas will increase substantially.

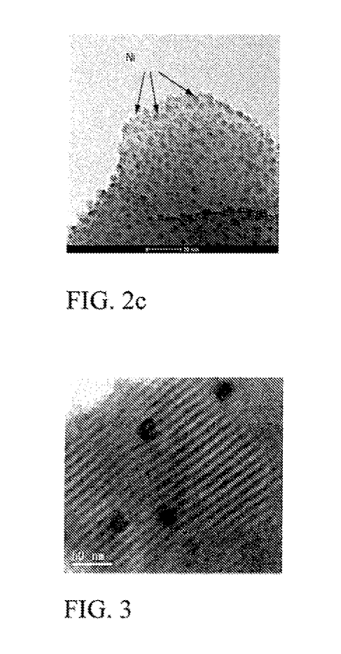

In accordance with one embodiment of the subject development, highly dispersed Ni nanoparticles are deposited on high specific surface α-alumina hollow fibers, along with a catalyst promoter film deposited on Ni/alumina catalysts by ALD. The subject development features at least the following advantages/improvements over current technologies:
1) The subject nano-engineered catalyst desirably can improve catalytic activity and stability
   Our studies have shown that the nano-engineered catalyst possessed:
      Higher activity than conventional catalysts (Table 2) due to highly dispersed ˜2-4 nm Ni nanoparticles compared to ˜10-30 nm Ni particles prepared by traditional methods (see FIGS. 2a and 2b). FIG. 2c is a TEM image showing Ni nanoparticles deposited on nonporous G-alumina nanoparticles by ALD;
      High stability due to a strong bonding between the nickel nanoparticles and substrates since the nickel particles were chemically bonded to the substrate during the ALD process; and
      The high thermal stability maintained high dispersion of Ni nanoparticles, which could inhibit coke formation.

TABLE 2
Comparison of activity for nono-engineered
and conventional catalysis.

| | CH4 reforming rate | | |
|---|---|---|---|
| | (L · h⁻¹gNi⁻¹) | | |
| Catalyst | 850° C. | 800° C. | 750° C. |
| Nano-engineered catalyst | 1,840 | 1,740 | 1,320 |
| prepared by ALD | | | |
| Conventional catalyst | 1,700 | 1,150 | 480 |
| prepared by incipient | | | |

FIG. 3 is a TEM image showing Ni nanoparticles synthesized by a conventional liquid phase method.
2) Novel geometric hollow fiber shape to increase the geometrical surface area
   The α-Al₂O₃ hollow fibers provide high thermal stability and mechanical strength for the catalyst as well as the following advantages over conventional substrates:
      High Packing Density: The specific area per unit volume for the alumina hollow fibers is as high as 3,000 m²/m³. This provides a high packing density for catalytic dry reforming applications.
      Low Pressure Drop: Whether the direct use of CO₂ in flue gas (13-15 vol. %) or the use of high-purity CO₂ (>95 vol. %) captured from flue gas using a CO₂ capture system, the pressure is low. With CO₂ compression being costly, a low pressure drop through the reactor is desirable. For the hollow fiber with a length of 60 inches (typical length for a hollow fiber module), the calculated pressure drop for the flow of dry reforming reactants is less than 0.2 psi when operating with our pressure-driven transport configuration at the design flow conditions.
3) Desired H₂/CO ratio for follow-up Fischer-Tropsch synthesis to produce C₅₊ hydrocarbons
   The syngas produced in accordance with processing of the subject development has a H₂/CO ratio of 0.7 to 0.95, whereas the benchmark technology steam reforming delivers a H₂/CO of about 3. This can be particularly significant in conjunction with applications such as Fischer-Tropsch fuel synthesis that produce high yield C₅₊ hydrocarbons, wherein the preferred H₂/CO ratio is 0.8.

Ni nanoparticles used in the practice of the subject development may, in accordance with one preferred embodiment, desirably and preferably be 2-6 nm in size. In another preferred embodiment, Ni nanoparticles used in the practice of the subject development are desirably and preferably 2-4 nm in size.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed includes:

1. A catalyst comprising nickel (Ni) nanoparticles supported on a hollow fiber substrate.

2. The catalyst of claim 1 wherein the hollow fiber substrate comprises alumina.

3. The catalyst of claim 1 wherein the hollow fiber substrate comprises α-Al₂O₃.

4. The catalyst of claim 1 wherein the nickel (Ni) nanoparticles are 2-6 nm in size.

5. The catalyst of claim 1 wherein the nickel (Ni) nanoparticles are deposited onto the hollow fiber substrate by atomic layer deposition.

6. The catalyst of claim 1 additionally comprising an overcoat of a promoter to increase catalyst performance in reforming of methane, wherein the promoter is selected from the group consisting of Al₂O₃, CeO₂, CaO and La₂O₃.

7. The catalyst of claim 1 additionally comprising an alumina ALD overcoat as a promoter to increase catalyst performance in reforming of methane.

8. The catalyst of claim 7 comprising multiple cycles of Al₂O₃ ALD overcoat.

9. The catalyst of claim 1 wherein the nickel (Ni) nanoparticles are nanoparticles selected from the group consisting of Ni+Co bimetallic nanoparticles, Ni+Pt bimetallic nanoparticles, and only nickel nanoparticles.

10. The catalyst of claim 1 wherein the nickel (Ni) nanoparticles are neat nickel nanoparticles.

11. A process for reforming methane, the process comprising:
contacting methane and carbon dioxide in the presence of the catalyst of claim 1.

12. A process for dry reforming methane, the process comprising:
introducing methane and carbon dioxide into a reactor containing a packed bed of a plurality of hollow fiber substrate supports carrying nickel (Ni) nanoparticles.

13. The process of claim 12 wherein the hollow fiber substrate support comprise α-Al₂O₃.

14. The process of claim 12 wherein the nickel (Ni) nanoparticles are 2-6 nm in size.

15. The process of claim 12 wherein the nickel (Ni) nanoparticles are deposited onto α-Al₂O₃ hollow fiber substrate supports by atomic layer deposition.

16. The process of claim 15 wherein the α-Al₂O₃ hollow fiber supports carrying nickel (Ni) nanoparticles include an overcoat of a promoter to increase catalyst performance in reforming of methane, wherein the promoter is selected from the group consisting of Al₂O₃, CeO₂, CaO and La₂O₃.

17. The process of claim 12 wherein the α-Al₂O₃ hollow fiber supports carrying nickel (Ni) nanoparticles include an alumina ALD overcoat as a promoter to increase catalyst performance in reforming of methane.

18. The process of claim 12 wherein the dry reforming produces syngas having H₂/CO ratio of no more than 0.95.

19. The process of claim 12 wherein the dry reforming produces syngas having H₂/CO ratio in a range of 0.7 to 0.95.

20. The process of claim 12 wherein the nickel (Ni) nanoparticles are nanoparticles selected from the group consisting of Ni+Co bimetallic nanoparticles, Ni+Pt bimetallic nanoparticles, and only nickel nanoparticles.

21. The process of claim 12 wherein the nickel (Ni) nanoparticles are neat nickel nanoparticles.

22. A method for producing a catalyst for dry reforming methane, the method comprising:
depositing nickel (Ni) nanoparticles onto a hollow fiber substrate support by atomic layer deposition.

23. The method of claim 22 wherein the nickel (Ni) nanoparticles are 2-6 nm in size.

24. The method of claim 22 wherein the hollow fiber substrate support comprises α-Al₂O₃.

25. The method of claim 24 additionally comprising applying by atomic layer deposition at least one layer of a metal oxide coating over the nickel (Ni) nanoparticles on the α-Al₂O₃ hollow fiber substrate support, the metal oxide coating increasing catalyst performance in reforming of methane.

26. The method of claim 22 wherein the nickel (Ni) nanoparticles are neat nickel nanoparticles.
